(19) United States
(12) Patent Application Publication
(10) Pub. No.: US 2013/0015145 A1
(43) Pub. Date: Jan. 17, 2013

(54) STORAGE DEVICE

(71) Applicant: Timothy A. Koepke, Winter Park, CO (US)

(72) Inventor: Timothy A. Koepke, Winter Park, CO (US)

(73) Assignee: ADVANCED LOCKER SYSTEMS, LLC, Winter Park, CO (US)

(21) Appl. No.: 13/546,997

(22) Filed: Jul. 11, 2012

Related U.S. Application Data
(60) Provisional application No. 61/506,487, filed on Jul. 11, 2011.

(51) Int. Cl. A47B 81/00; E05B 73/00

(52) U.S. Cl. 211/5; 211/4

(57) ABSTRACT

A storage device includes a support assembly that partially rotates relative to a base assembly from a closed, storage position to an open, loading position, and vice versa. When the storage device is in the open, loading position, an object, such as a bicycle, can be inserted therein by way of an access opening. Rotation of the support assembly positions the object in at least an inclined position which inhibits theft of the object.

### CROSS-REFERENCE TO RELATED APPLICATION

The present application is based on and claims the benefit of U.S. provisional patent application Ser. No. 61/506,487, filed Jul. 11, 2011, the content of which is hereby incorporated by reference in its entirety.

### BACKGROUND

The discussion below is merely provided for general background information and is not intended to be used as an aid in determining the scope of the claimed subject matter.

The invention concerns public on-demand storage devices. In particular, aspects of the invention are directed to storage devices such that may be used but not limited to store bicycles on demand at a public transportation station. Since the on-demand storage lockers are located in public places, there is a need to inhibit theft and/or vandalism of the object stored therein.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An aspect of the present invention relates to a storage device for an object that includes a base assembly and a support assembly configured to rotate relative to the base assembly from a loading position to a storage position. The storage position inhibits removal of the object from the support assembly.

Another aspect of the present invention relates to a storage device for an object that includes a base assembly having interconnected base frame members and a support assembly configured to rotate relative to the base assembly from a loading position to a storage position. The support assembly has interconnected support frame members to define an access opening through which the object is inserted into the storage device in the loading position. At least one of the base assembly and support assembly includes elements to inhibit removal of the object from the storage device in the storage position. Elements to inhibit removal of the object can include rods, frames, plates and/or spokes.

Another aspect of the present invention relates to a storage device for an object, where the storage device includes a base assembly and a support assembly configured to rotate relative to the base assembly from a loading position to a storage position. The support assembly includes interconnected support frame members to define an access opening through which the object is inserted into the storage device in the loading position. The support assembly further includes a holding device configured to hold the object in at least an inclined position so as to inhibit removal of the object through the access opening in the storage position.

Additionally, any of the embodiments described above may include one or more of the following features. An access opening can be provided through which the object is loaded on the support assembly such that in the loading position removal of the object through the access opening in the storage position is inhibited. In a further embodiment, the base assembly includes a base assembly access opening formed from interconnected support members thereof. The access opening 115 is aligned with the base assembly opening 121 in the loading position.

A loading mechanism can be provided that is configured to receive the object through the access opening. The loading mechanism can include a loading tray that is configured to receive wheels of a bicycle and guide the wheels thereon. The loading mechanism can include a moveable wheel support configured to engage the wheel of a bicycle and prevent backwards movement of the bicycle as the support assembly begins movement toward the closed, storage position. Optionally, a steering guide is provided and configured to direct handlebars of the bicycle and hold the bicycle in an upright position.

If desired, a counterweight is disposed on the support assembly and configured to aid in moving the support assembly from the open, loading position to the closed, storage position. A motion control mechanism can be provided and is configured to aid in rotating the support assembly from the loading to the storage position and/or operably configured to dampen rotation of the support assembly relative to the base assembly. The motion control mechanism can optionally be a lift support or an actuator.

An object holding assembly can be provided and configured to hold the object from falling in the storage position. The object holding assembly includes opposed rods driven by cam plates and configured to slide toward each other in guides. Optionally, caliper arms can be provided that move controllably with respect to the cam plates.

These and various other features and advantages that characterize the claimed embodiments will become apparent upon reading the following detailed description and upon reviewing the associated drawings.

### BRIEF DESCRIPTION OF THE DRAWINGS

FIG. 1 is a front perspective view of an exemplary storage device showing the storage device in a fully open, loading position receiving an object.

FIG. 2 is a front perspective view of the storage device showing the storage device in the fully open, loading position with the object disposed therein.

FIG. 3 is a front perspective view of the storage device showing the storage device in a partially rotated position.

FIG. 4 is a front perspective view of the storage device showing the storage device in a fully closed, storage position.

FIG. 5 is a front perspective view of an exemplary support assembly showing the support assembly in a partially-open position.

FIG. 6 is a perspective view of a holding assembly.

FIG. 7 is a perspective view of the support assembly in a fully closed, storage position and the stationary support base removed.

FIG. 8 is a side view of the support assembly with portions removed.

FIG. 9 is a front view of the support assembly.

FIG. 10 is an enlarged view of a portion of FIG. 9.

FIG. 11 is a perspective view of the support assembly with some portions of the base assembly.

FIG. 12 is an enlarged view of a portion of FIG. 11.

FIG. 13 is an exploded view of the loading mechanism.

FIG. 14 is a front view of a plurality of storage devices.

FIG. 15 is a rear view of the plurality of storage devices.

FIG. 16 is a front view of the plurality of storage devices with portions removed.

FIG. 17 is an enlarged view of a portion of FIG. 16.

FIG. 18 is a schematic perspective view of an actuating assembly of a grab mechanism.

FIG. 19 is a schematic perspective view of the grab mechanism.

FIG. 20 is a schematic perspective view of the grab mechanism.

FIG. 21 is a perspective sectional view of a holding device.

FIG. 22 is an elevational sectional view of the holding device.

The figures now have been illustrated and will be described in clear detail enabling one of ordinary skill to make and use the present invention. Modifications can be made without departing from the spirit and scope of the invention.

### DETAILED DESCRIPTION OF ILLUSTRATIVE EMBODIMENTS

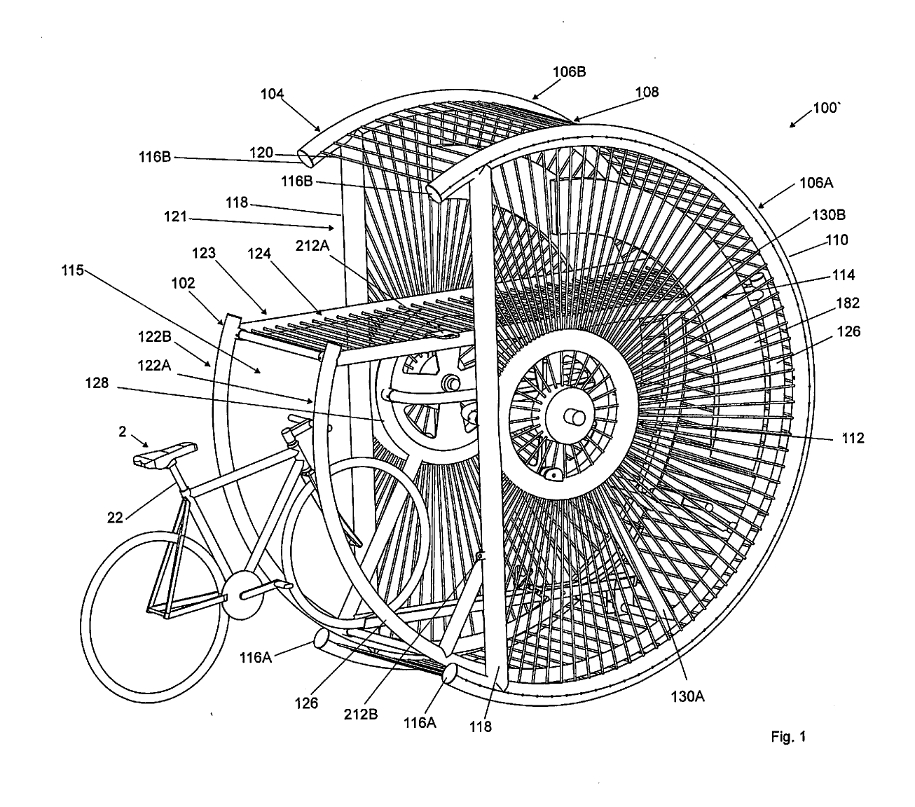

An exemplary embodiment of a storage device 100 is illustrated in FIG. 1. The storage device 100 includes a support assembly 102 (herein in the form of a carriage) that rotates to a vertical position and a base assembly 104 that is stationary, but supports the support assembly 102 for partial rotation. In particular, support assembly 102 is configured to partially rotate so as to allow the storage device 100 to operably change from a closed, storage position to an open, loading position, and vice versa. When the storage device 100 is in the open, loading position, an object 2 can be disposed on the support assembly 102, and in an advantageous embodiment being inserted therein by way of an access opening 115 defined by interconnected support members of the support assembly 102. Once the object 2 has been disposed on and typically held on the support assembly 102, the support assembly 102 partially rotates, thereby inverting the object 2 from a horizontal position to a vertical position with respect to fixed support surfaces, such as the ground, a sidewalk, or a street. Typically, when the storage device 100 is in the closed, storage position, object 2 is securely held in place in the vertical position.

The configuration of storage device 100 illustrated in FIG. 1 provides advantages, such as but not limited to, providing a compact storage position that inhibits access to object 2. As illustrated in FIG. 1, object 2 in this exemplary embodiment is a bicycle 22. Although the present invention has been described and illustrated herein with reference to bicycles, it should be understood the invention should not be limited only to bicycles. Rather, the invention can be implemented with a variety of objects, including motorized scooters, snowmobiles, alternative terrain vehicles, dirt bikes, motorcycles, surf boards, skis and sleds. Moreover, the invention can be implemented with a variety of other, non-vehicular objects, and in particularly but not limited to, elongated objects given that the vertical storage position is compact (relative to a horizontal viewpoint).

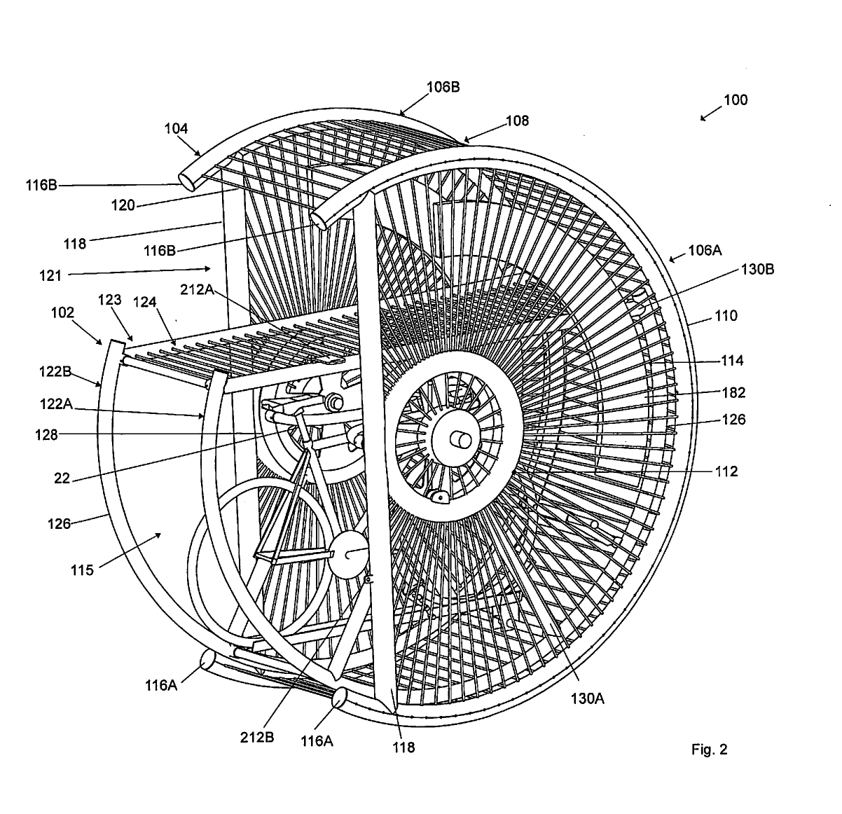

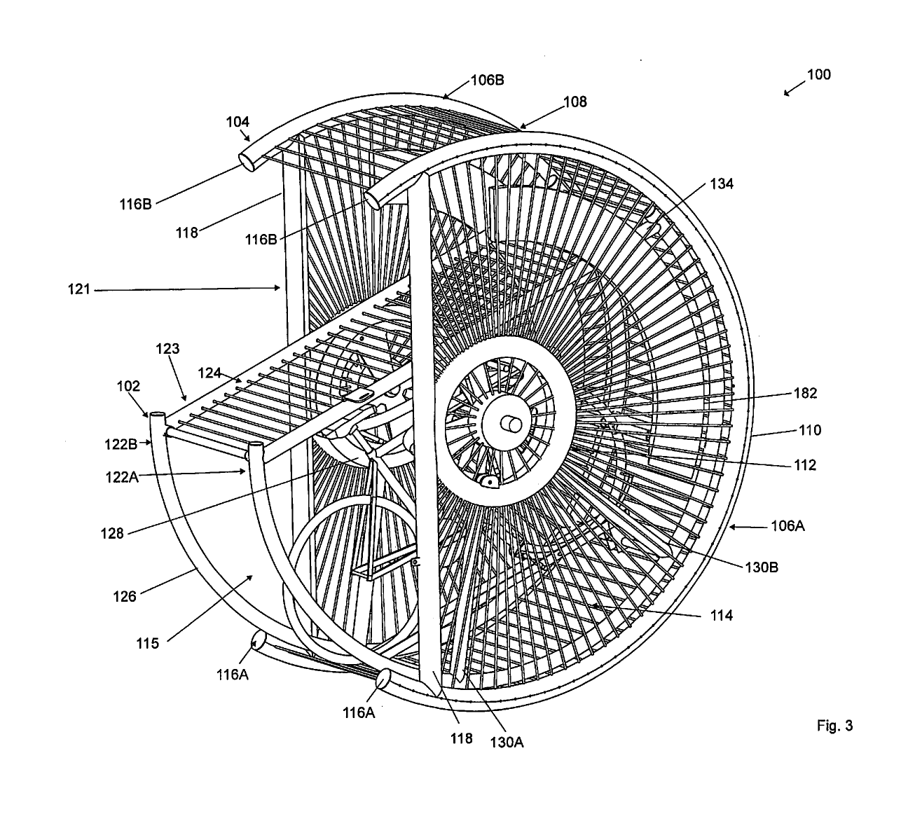

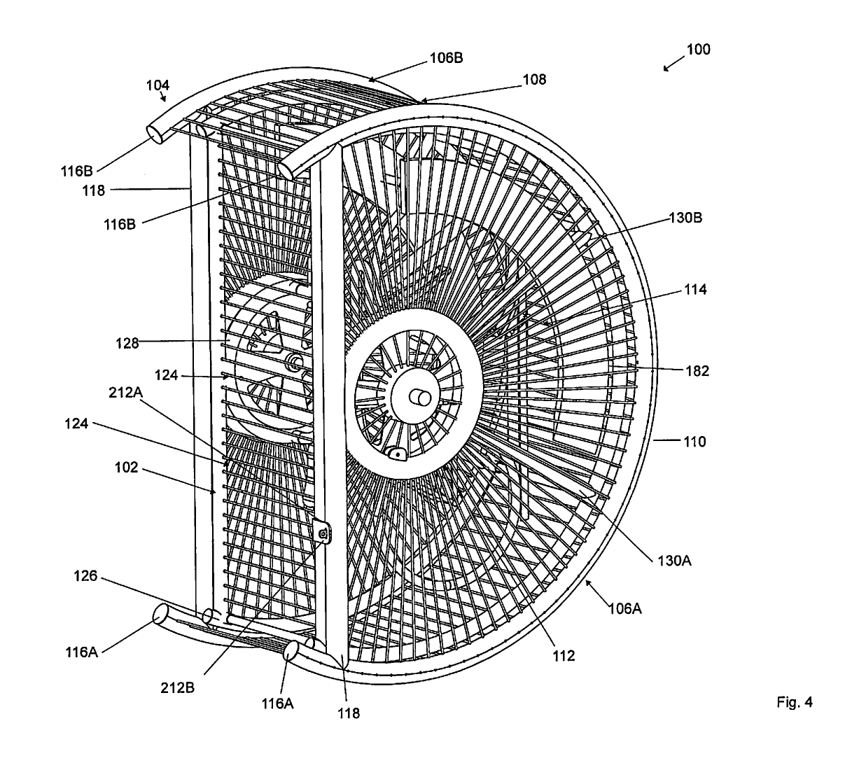

As illustrated in FIGS. 1-4 and discussed above, storage device 100 includes the support assembly 102, which is configured to support and rotate the object 2, herein bicycle 22, to a position that inhibits unauthorized access and/or theft. In the closed, storage position, in the embodiment illustrated, the support assembly 102 is generally located within the outer boundaries of the base assembly 104. Support assembly 102 can be configured so that when the support assembly 102 rotates relative to the base assembly 104, the support assembly 102 does not contact support surfaces, such as the ground, a sidewalk, or a street.

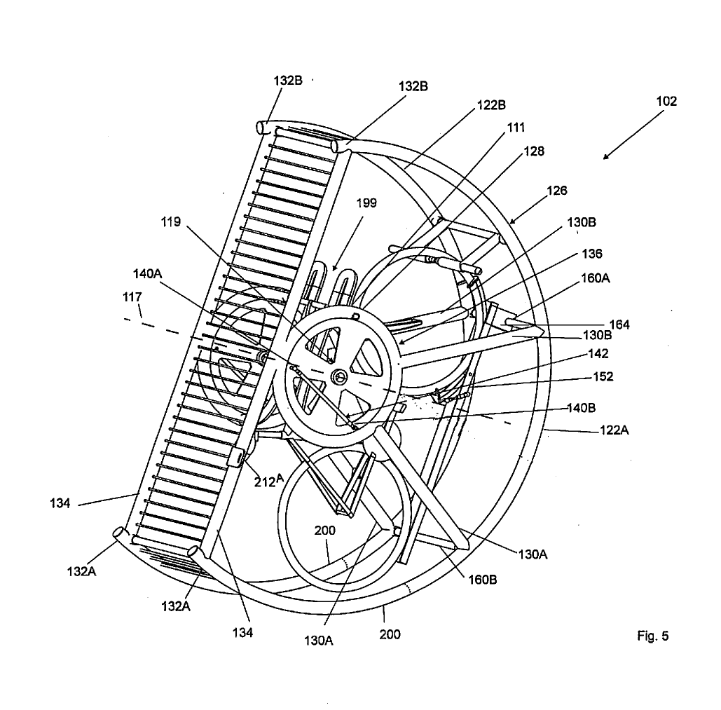

In the embodiment herein illustrated, base assembly 104 comprises interconnected base frame members 106A, 106B connected together by way of at least one and preferably a plurality of base connecting members 108, herein each depicted as a rod 120. The interconnected base frame members 106A, 106B are configured to inhibit access to the object(s). Interconnected base frame members (in the exemplary embodiment portions of frame members 106A, 106B) define a base assembly opening 121 through which the object is inserted through in the loading position. The access opening 115 is aligned with the base assembly opening 121 in the loading position. Each base frame member 106A, 106B comprises an outer curved base rib 110 and an inner, herein by way of example, circular support 112, where the outer curved base rib 110 has a radius of curvature that is greater than the radius of the inner circular support 112. The outer curved base rib 110 is joined to the inner circular support 112 herein by way of spokes 114 that are spaced apart from one another so as to prevent unauthorized access to the object(s) 2 inside storage device 100. In the exemplary embodiment herein provided in FIG. 5, each inner circular support 112 comprises a carriage plate 111 configured to have an aperture 119 or other structure (e.g., a bearing) that provides a pivot point or axis of rotation 117 of support assembly 102. The outer curved base rib 110 forms an incomplete circle or arc where ends 116A and 116B of the outer curved base rib 110 are joined together by way of a base cross bar 118. In one embodiment, the base cross bar 118 is straight and is placed close to, but not necessarily at the ends 116A, 116B of, outer curved base rib 110. In the exemplary embodiment, configuration of the base frame members 106A, 106B, base connecting member(s) 108 and connecting spokes 114 is such so as to inhibit access to the object 2 from the sides, top and bottom of the base assembly 104. It should be noted, however, that inhibiting access to the object by structures disposed on the base 104 is but one embodiment, in that structures (as discussed below) can be provided on the support member 102, if desired, and furthermore that the connecting members 108 and connecting spokes 114 are used by way of example, and that any other structure that inhibits access to object 2 stored inside the storage device 100 can be used.

As also illustrated in FIGS. 5-8, support assembly 102 herein comprises two curved interconnected support frame members 122A, 122B that are connected to one another by way of at least one or more connecting member(s) 124 which define a connecting support surface 123. Each curved support frame member 122A, 122B includes an outer curved carriage support member 126 and an inner, herein by way of example circular carriage support member 128, where outer curved carriage support member 126 has a radius of curvature that is larger than the radius of the inner circular carriage support member 128. Each outer curved carriage support member 126 is connected to the corresponding inner circular carriage support member 128 herein by way of two bars 130A, 130B, extending radially from the axis of rotation, spaced approximately 45 degrees from each other. Each outer curved carriage support member 126 forms an incomplete circle or arc having ends 132A, 132B connected by way of a carriage support cross bar 134 which, in the embodiment illustrated, is shown as being straight. As described in connection with the base assembly 104 above, in one embodiment, the straight carriage support cross bar 134 is disposed close to, but not necessarily at the ends 132A, 132B, of outer curved carriage support member 126.

In the illustrated embodiment, the connecting member(s) 124 can be configured so as to inhibit access to the object 2 from the front where connecting member(s) 108 and spokes 114 (or other suitable structure) on the base assembly 104 inhibits access from the top, bottom and sides. However, it should be noted that this is but one configuration to inhibit access. For example, if desired, structures can be configured on the sides of the support assembly 102 instead of the structures (spokes 114) on the sides of the base assembly 104. Likewise, structures can be provided on the support assembly 102, for example additional connecting members 124 so as to inhibit access from the top and rear, while still leaving the access opening 115. If desired, a cover can be on any of the sides (top, bottom, left, right, front or rear) or portions thereof of the storage device 100 so as to shield the object therein from the weather or sight. The cover(s) can be in the alternative or in addition to the other structures that inhibit access to the object. Further, it should also be noted that the specific support structure shown for the base assembly 104 and support assembly 102 (e.g., members 106A, 106B, 122A, 122B, inner supports 112, 128) should not be construed as limiting. In an advantageous embodiment, the storage device 100 includes a protective ring 163 configured to prevent access to a pivot pin for axis 117 via a gap formed between the inner circular carriage support member 128 and the inner circular support 112. It should be noted, base assembly 104 can be configured to support assembly 102 for partial rotation from a single side of the support assembly 102, if desired.

In an advantageous embodiment, the support assembly 102 is coupled to the base assembly 104 with a motion control mechanism. It should be noted that the motion control mechanism can be a lift and/or a damping mechanism. In the embodiment illustrated, the lift mechanism is a telescoping lift support 142. The lift support 142 can comprise an elongated rod movable relative to a gas charged cylinder, where the charged cylinder stores energy to aid in rotating the support assembly 102 from the loading position to the storage position. In such an embodiment, no external power source is needed. However, in another embodiment, the motion control mechanism can be powered, for example comprising a linear actuator (similar to that of the lift support 142 illustrated) or a rotary actuator, where the actuator can be hydraulically, pneumatically or electrically powered from a suitable power source, not shown. It should be noted, one or more lift supports can be provided on each side of the support assembly 102.

The telescoping lift support 142 extends and retracts when the storage device 100 moves from the loading to the storage position, and vice versa. In operation, when the storage device 100 is initially in the open position, the telescoping lift support 142 is in the retracted position. As the support assembly 102 moves toward the storage position, the lift support 142 begins to extend and assist with rotation of the support assembly 102, obtaining maximum extension proximate the storage position, and thereafter beginning to retract until the support assembly 102 reaches the storage position. The slight retraction of the lift support 142 from maximum extension in the storage position of the support assembly 102 can help retain the support assembly 102 in the storage position rather than having it rotate back to the loading position immediately upon release when it is in the storage position.

In the embodiment illustrated, an end 140A of the lift support 142 (or linear actuator) is connected to the support assembly 102 (herein inner circular carriage support member 128), while a second end 140B is pivotally connected to the base assembly 104 (herein inner circular support member 112) where the connection locations are chosen so that the lift support 142 generates torque to aid in rotation of the support assembly 102. As appreciated by those skilled in the art, the lift support 142 (or other actuator) also damps motion of the support assembly 102 from the storage position back to the loading position. In an alternative embodiment, a damper may be all that is necessary.

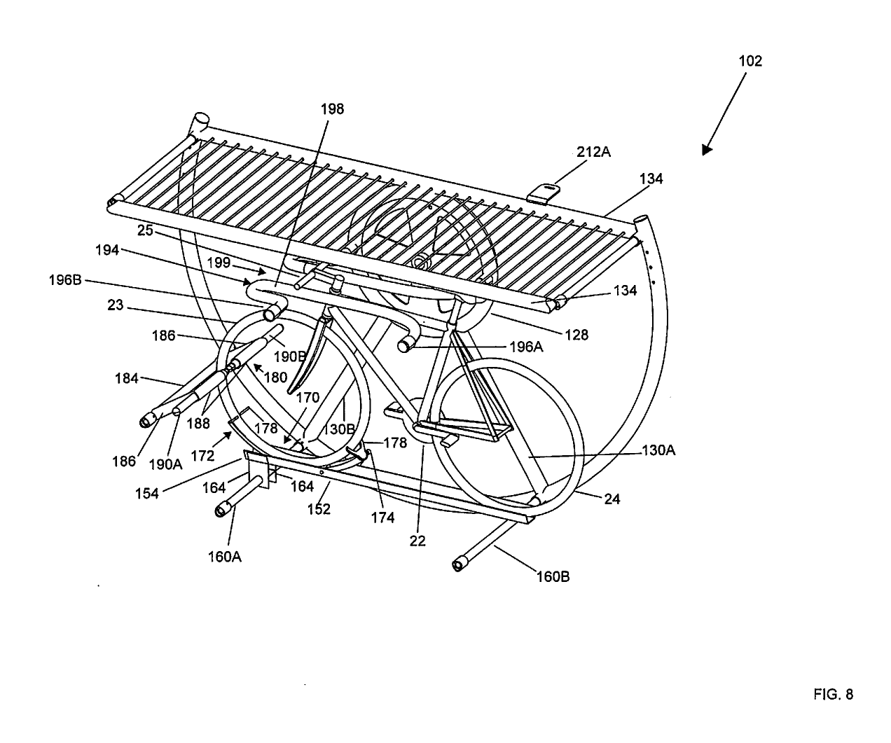

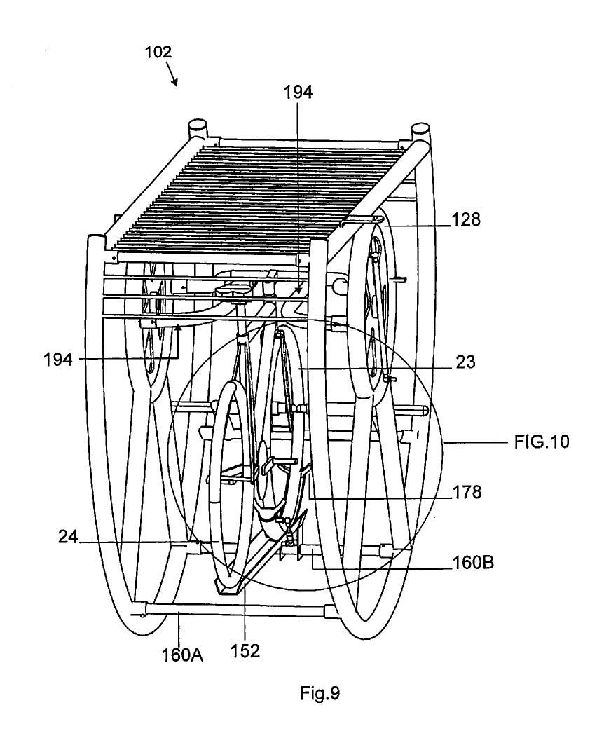

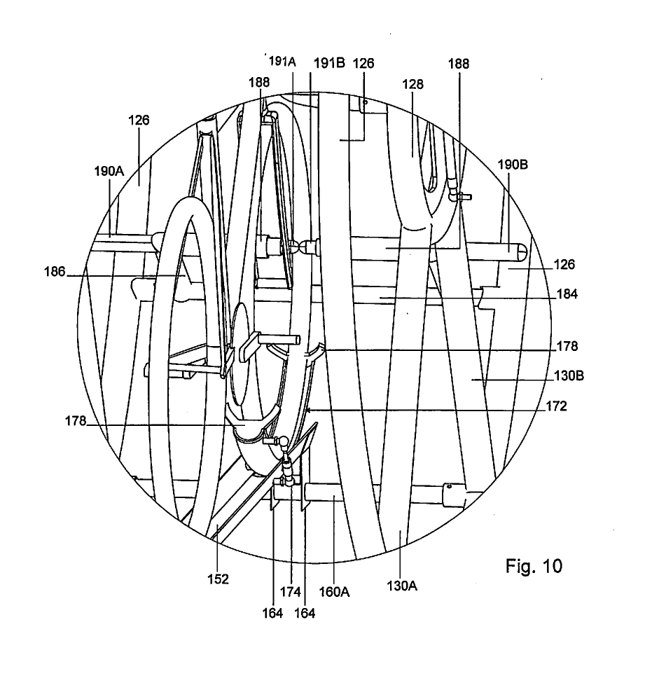

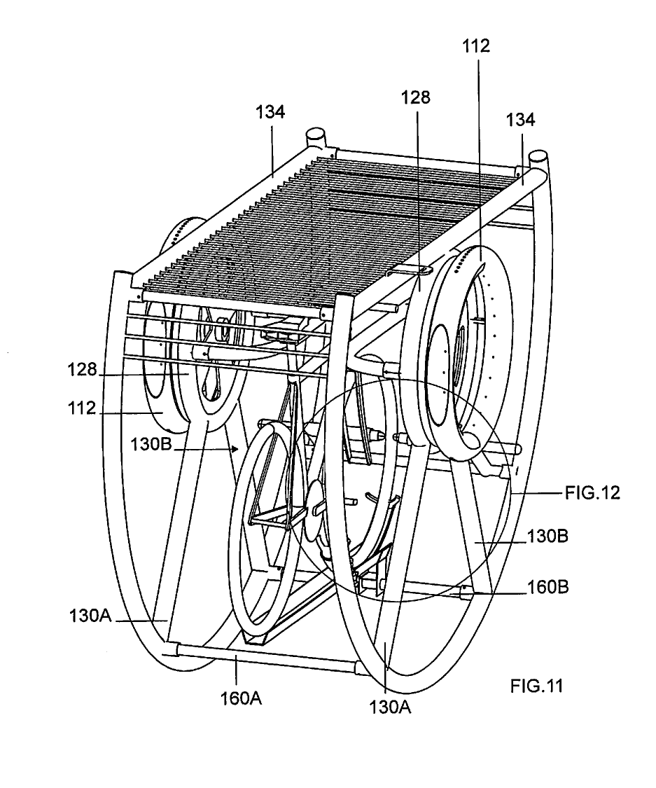

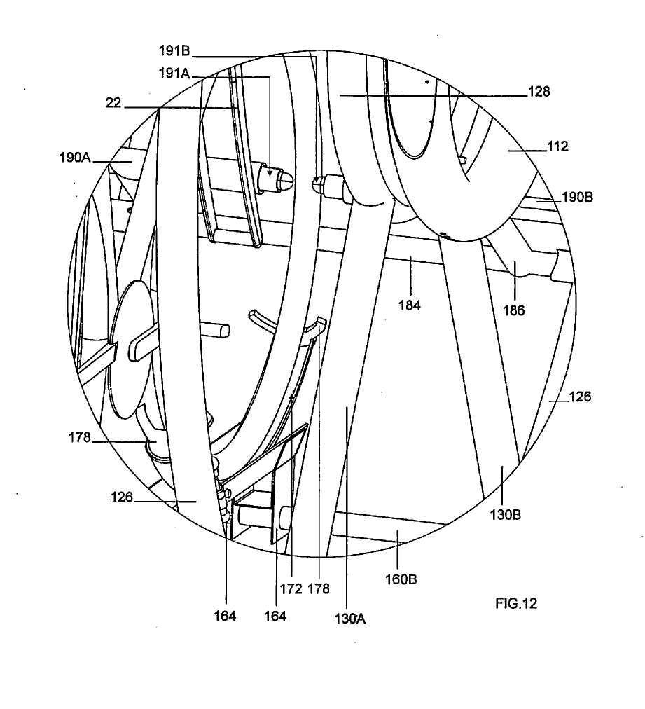

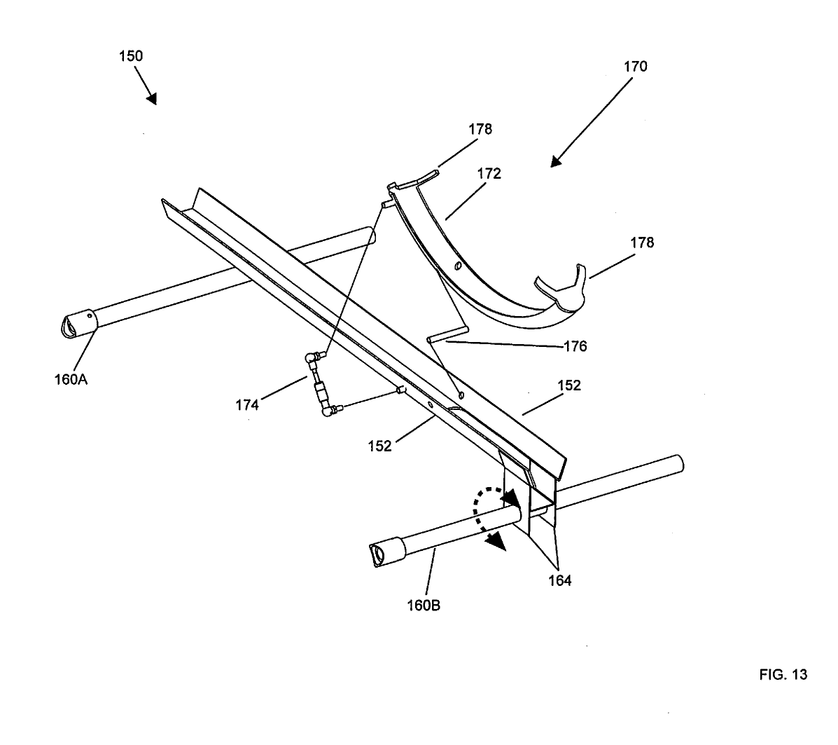

FIGS. 8-13 illustrate a loading mechanism 150 (FIG. 13) forming part of the support assembly 102 that is particularly useful for loading a bicycle 22 onto the rotating support assembly 102. The loading mechanism 150 includes a loading tray 152 which receives wheels of the bicycle 22 and guides the wheels thereon so that a user operating the storage device 100 can simply push bicycle 22 into the storage device 100.

In the embodiment illustrated, the loading tray 152 is secured to support members 126 of support assembly 102 using crossbars 160A, 160B and mounting plates 164 that join the crossbar 160B to the loading tray 152. The crossbars 160A, 160B are attached to the curved support frames 122A, 122B. In one embodiment, the mounting plates 164 can rotate around 160B so that the loading tray 152 can be inclined in the loading position of the support assembly where an end of the loading tray 152 proximate the opening 115 engages the ground. Rotation of the loading tray 152 on crossbar 160B also allows the loading tray 152 and bicycle to freely hang together, substantially vertical, in the storage position. Although the loading tray 152 could be fixedly joined to the crossbar 160B in an inclined position in the loading position, in the storage position, a free end of the bicycle 22 not held by a holding assembly 180 (discussed below) may tend pull away from the loading tray 152, which may be undesirable.

In a further embodiment a movable wheel support 170 is configured to engage the wheel 23 of the bicycle 22 and prevent backwards movement of the bicycle 22 as the support assembly 102 begins movement toward the closed, storage position. In the embodiment illustrated, the movable wheel support includes a rocking tray portion 172 pivotally joined to the loading tray 152 with a pivot pin 176. The rocking tray portion 172 is curved in a manner similar to a wheel of the bicycle and includes ends 178 to inhibit movement of the wheel from the tray portion 172. The tray portion 172 and location of ends 178 are configured to accommodate wheels of different sizes. For instance, common wheel sizes include 20 to 27 inches. However, wheels of smaller or larger sizes can be accommodated. A locking shock 174 is pivotally joined to the tray portion 172 and the loading tray 152 to selectively inhibit rocking motion of the tray portion 172.

As the bicycle 22 is rolled and pushed forward onto the loading tray 152, the wheel 23 of the bicycle 22 engages the tray portion 172, which tilts downwardly to accept the wheel 23 therein. The curvature of the tray portion 172 is designed, in part, to help hold the weight of the bicycle 22 as well as inhibit backwards movement of the bicycle 22 during loading. The movable wheel support 170 also provides positive feedback that the bicycle 22 is in the proper position and that the bicycle 22 is far enough forward so that the whole length of the bicycle 22 has been inserted into the support assembly 102 and movement toward the closed, storage position can begin safely. The locking shock 174 is configured to hold the tray portion 172 such that the tray portion 172 provides vertical support when the bicycle is in the vertical position.

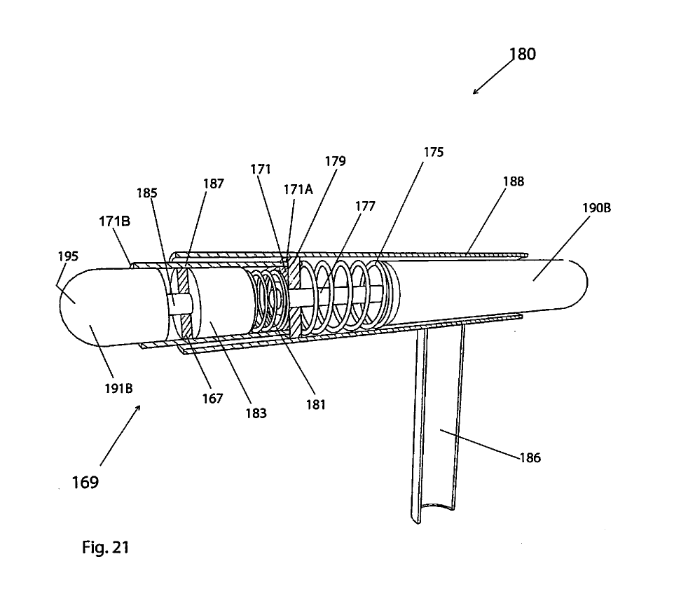

In one embodiment, the storage device 100 also includes an object holding assembly 180 configured to ensure that the object 2 (herein bicycle 22) will not slide backwards as the loading tray 152 begins to invert the bicycle 22 as well as hold the bicycle 22 in the vertical, storage position. In the embodiment illustrated, the object holding assembly 180 includes opposed rods 190A and 190B configured to slide toward each other in guides 188. Rods 190A, 190B are spring-biased by way of a compression spring 175 (FIG. 21) to an open position and disposed on the support assembly 102 so as to come together between portions of the bicycle, for example, the spokes of a wheel; however, this should not be considered limiting in that the rods 190A, 190B can be disposed to support assembly 102 so as to come together and thereby hold another portion of the bicycle such as a portion of the frame.

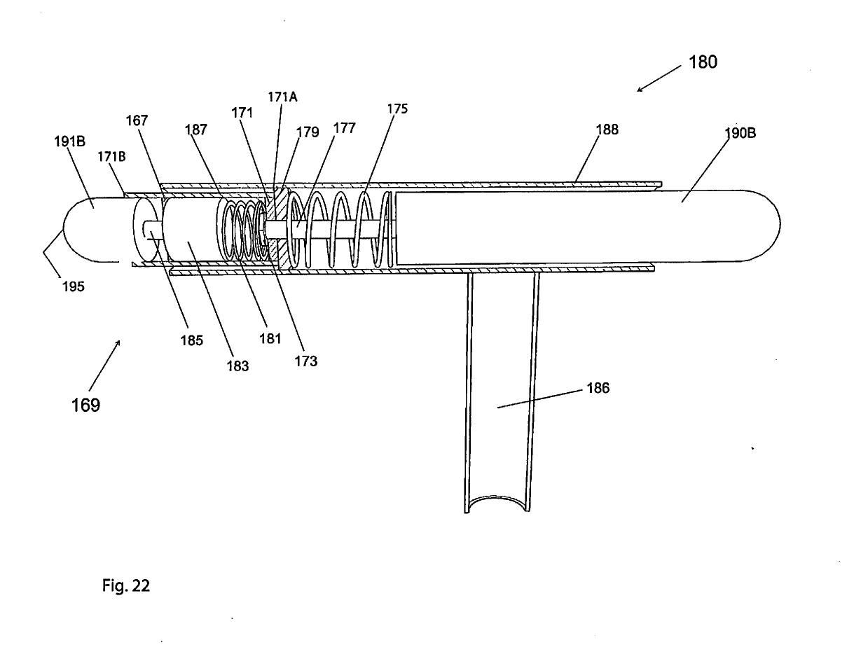

In the embodiment illustrated, each of the opposed rods 190A, 190B include a compliant pin assembly 169 that engage each other or are at least substantially positioned proximate each other in the storage position of the support assembly 102. Referring to FIGS. 21 and 22, compliant pin assembly 169 includes a slidable guide housing 187 for a displaceable pin 191B. One end 171A of the guide housing 187 includes a support 171 that engages a fixed element 179 secured to guide 188. An opposite end 171B of the guide housing 187 receives the pin 191B. A first end of a connecting rod 177 is joined to the rod 190B, while a second end is secured to support 171 to move therewith (i.e. the guide housing 187). The rod 177 slidably extends through an aperture in the fixed element 179. A compression spring 181 disposed in guide housing 187 biases the pin 191B out of the guide housing 187. In the embodiment illustrated, the pin 191B includes base portion 183 upon which the compression spring 181 engages, wherein the remote end of pin 191B is connected to base portion 183 with a connecting rod 185. Outward movement of the base portion 183 and thus the pin 191B out of the housing 187 is limited by a stop element 167 secured to the housing 187.

In operation, pin assembly 169 allows the pin 191B to engage the wheel 23 with compliance so as to inhibit damage to the wheel 23 such as a spoke due to the axial movement of the pin 191B via compression spring 181, wherein axial movement of the guide housing 187 is controlled by movement of rod 190B. A remote end 195 of the pin 191B is convex and smooth so as to slide off of spokes of the wheel 23 so as to inhibit damage. In a further embodiment, the guide housing 187 can be joined to rod 177 or rod 190B (via connecting rod 177) so as to allow for a change in an angular position or laterally relative to the guide 188 such that the remote end 195 can get around the spoke 114 of the bicycle 22, should the need to do so arise due to the position in which the wheel 23 is secured in the moveable wheel support 170. Likewise, the pin 191B can be disposed in guide housing 187 to allow some limited lateral and/or angular movement, if necessary, to get around the spoke 114 of the bicycle 22.

In the embodiment illustrated, rods 190A, 190B hold the front wheel 23 and hence the bicycle in a vertical position when the support assembly 102 is in the storage position. Supports 184 and 186 are secured to the support assembly 102 as needed to hold guides 188 and rods 190A, 190B where desired.

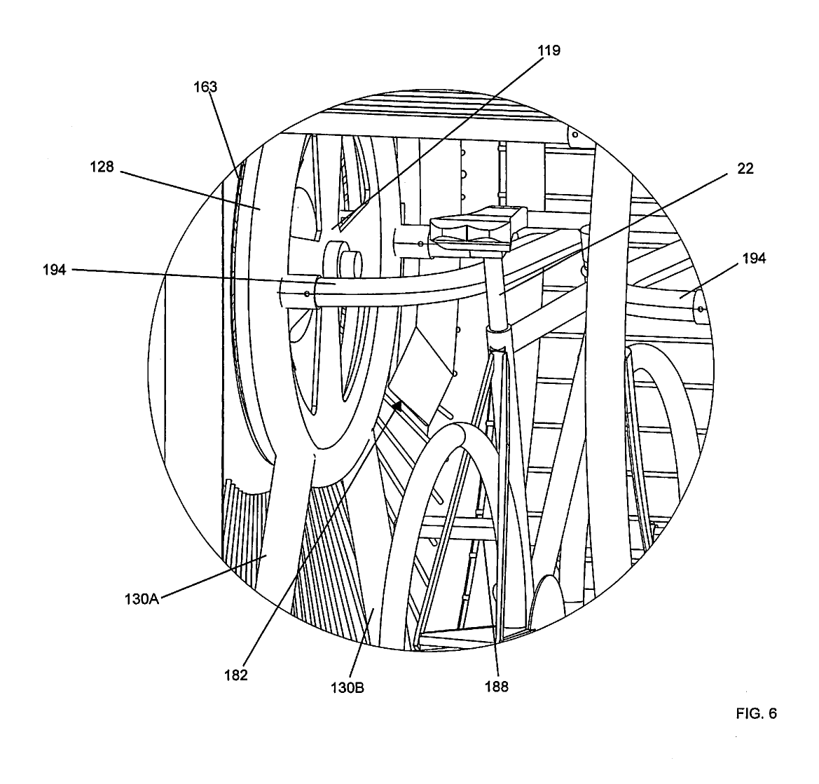

Rods 190A, 190B are displaced to a closed position by coming in contact with cam plates 182, where each cam plate 182 is secured to base assembly 104. Each cam plate has a thickness at a first end (FIG. 6) that is smaller than a thickness in a middle portion thereof. In operation, after the bicycle 22 has been loaded into the loading tray 152, the user causes rotation of the support assembly 102 relative to the base assembly 104. The ends of rods 190A, 190B will contact cam plates 182 and move toward each other during rotation.

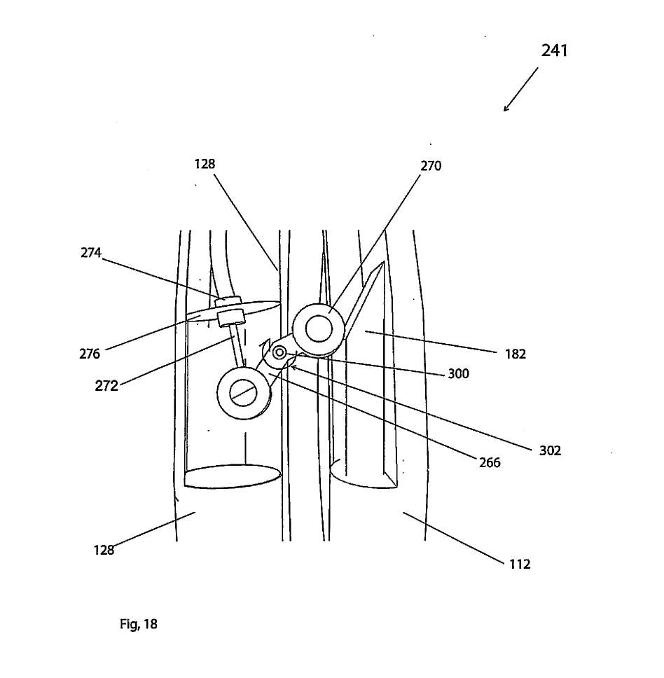

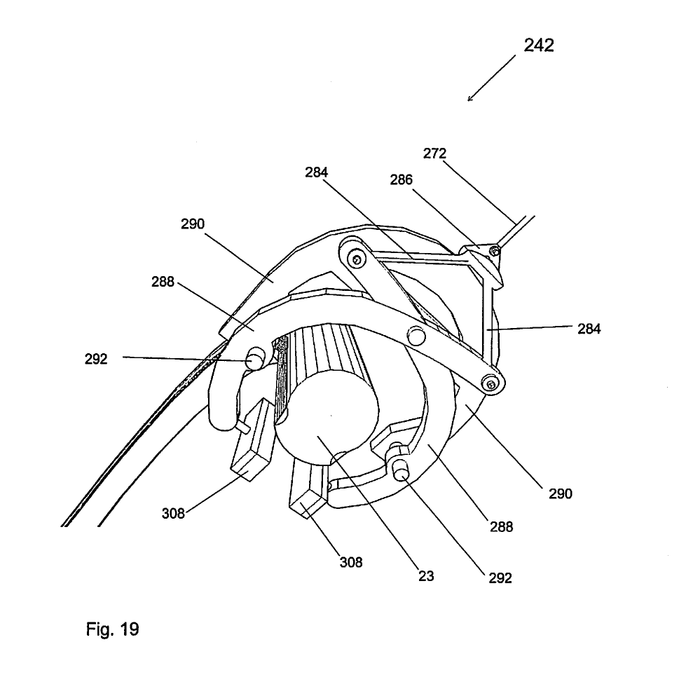

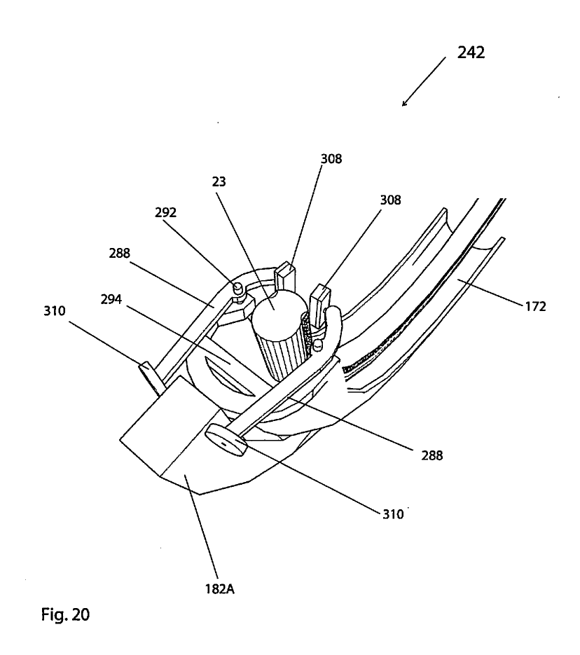

In a further embodiment shown in FIG. 19-20, the object holding assembly comprises a grab mechanism 242 configured to grab and hold in place the object 2 desired to be stored inside the storage device 100. An actuating assembly 241 operates the grab mechanism 242 due to rotational movement of the support assembly 102. Generally, the actuating assembly 241 includes an actuator arm 266 connected via a cable 272 to the grab mechanism 242, as illustrated in FIG. 18. When the support assembly 102 is rotated from the open, loading position to the closed, storage position, the actuator arm 266 operates to pull on the cable 272 to close the grab mechanism 242 via displacement of caliper arms 288 (shown in FIGS. 19 and 20).

Referring to FIG. 18, the actuator arm 266 is pivotally mounted to the inner circular carriage support member 128 and rotates with the inner circular carriage support member 128 during rotation of the support assembly 102. The actuator arm 266 selectively engages cam plate 182 which is secured to the member 112. In particular, a first end of the actuator arm 266 is connected to an end of the cable 272 remote from the grab mechanism 242. A second end of the actuator arm 266 engages the cam plate 182 and can optionally include a roller 270. The actuator arm 266 is biased by a torsion spring represented by arrow 300 (the arrow indicating the direction of bias) on a pivot axis 302. The torsion spring 300 retains the actuator arm 266 in a position corresponding to the caliper arms 288 apart from each other as found in the loading position of the support assembly 102. If desired, the actuator arm 266 can be mounted to frame member 126 where the cam plate 182 is then secured to frame member 110. Likewise, the mounting of the actuator arm 266 and the cam plate 182 can be reversed.

When the storage device 100 rotates from the loading position to the storage position, the actuator arm 266 will move with the support assembly 102, where the roller 270 will contact the cam plate 182, which will pivot the actuator arm 266, thereby pulling the cable 272 to pull the caliper arms 288 together to grab the wheel of the bicycle. The cam plate 182 extends along a portion of the perimeter of the member 112 so that when the support assembly 102 is in the storage position, the caliper arms 288 are pulled together. The position of the actuator arm 266 on the inner circular carriage support member 128 and the position of the cam plates 182 on the member 112 are selected so as to grab the bicycle with slight rotation of the support assembly 102 from the loading position. Rotation from the storage position to the loading position of the support assembly 102 causes the actuator arm 266 to rotate back to the position illustrated in FIG. 18, where the actuator arm 266 is rotated by the spring 300 to open the caliper arms 288. Cable tension nuts 274 mounted on bracket 276 are provided to adjust operation of the cable 272.

As shown in greater detail in FIG. 19, grab mechanism 242 includes a caliper cable 284 connected to a cable yoke 286. Grab mechanism 242 further includes gripper arms 288 that are each pivotally connected to a gripper frame 290 by way of a pin 292. The gripper frame 290 preferably is secured to the support assembly 102 to move therewith. To prevent damage to the object 2, the gripper 242 can further include at least two gripper pads 308 located on the ends of the caliper arms 288.

In another embodiment of the grab mechanism 242 illustrated in FIG. 20, motion of caliper arms 288 is controlled directly via a cam plate 182A. The cam plate 182A is secured to the base assembly 104. In the embodiment illustrated, rollers 310 on each of the caliper arms 288 engage the cam plate 182A on opposite sides. The caliper arms 288 are configured to move apart from each other as the width of the cam plate 182A widens, thereby guiding the caliper arms 288 to pivot around the wheel 23 of the bicycle 22 and gripper pads 308 toward each other. In this embodiment, the caliper arms 288 are mounted to a support 294 that in turn is mounted to the end of tray 172, although it should be understood this is but one location for mounting grab mechanism 242 in that can be mounted to any portion of support assembly 102.

In an advantageous embodiment, the loading mechanism 150 can include a guide 194 that guides handlebars 25 of the bicycle 22 and helps hold the bicycle 22 in an upright position during loading and unloading. The guide 194 has a first end 196A and a second end 196B attached to the support assembly 102. Each of the guides 194 extend inwardly from the first end 196A toward each other so as to form a guiding alley 198 that receives portions of the handlebars 25 of bicycle 22. In one embodiment, the guiding alley 198 formed by the steering guide 194 extends as far forward as the front tire 23 of the bicycle 22. A space 199 between the guides 194 is provided for the frame and/or centerpost of the handlebars 25.

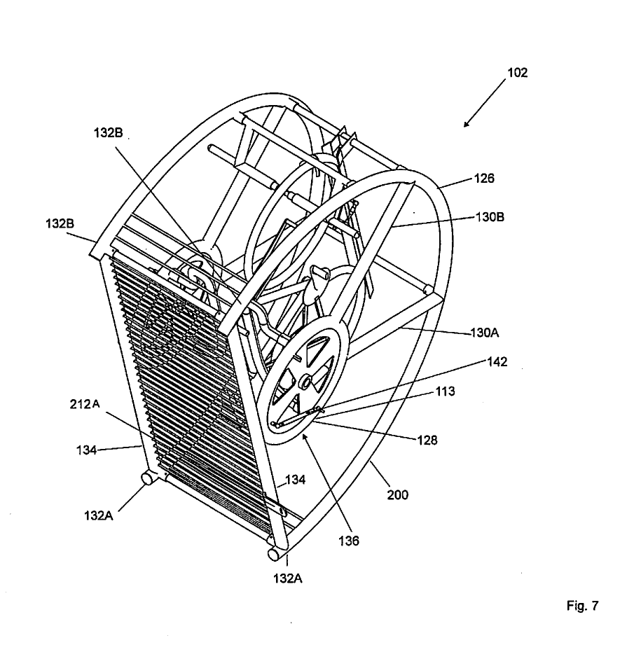

In an advantageous embodiment, the storage device 100 can include a counterweight 200 to aid in moving the support assembly 102 from the loading position to the storage position. The counterweight 200 can be disposed anywhere on the support assembly 102 in order to provide such operation. In one particular embodiment as illustrated in FIG. 13, the counterweight 200 can be at the bottom of the support assembly 102 in a crossbar 202 that can be configured to hold the weight associated with the counterweight 200. In another particular embodiment illustrated in FIGS. 5 and 7, the counterweight 200 is placed inside of at least one of the outer curved carriage support members 126. For example, the counterweight 200 can include sand or concrete that is disposed inside the outer curved carriage support member 126. In a further embodiment, the counterweight 200 is located in the portion of the rotating support frames 122A 122B closest to the access opening 115. In an advantageous embodiment, the counterweight 200 is generally proportional to the weight of the object 2.

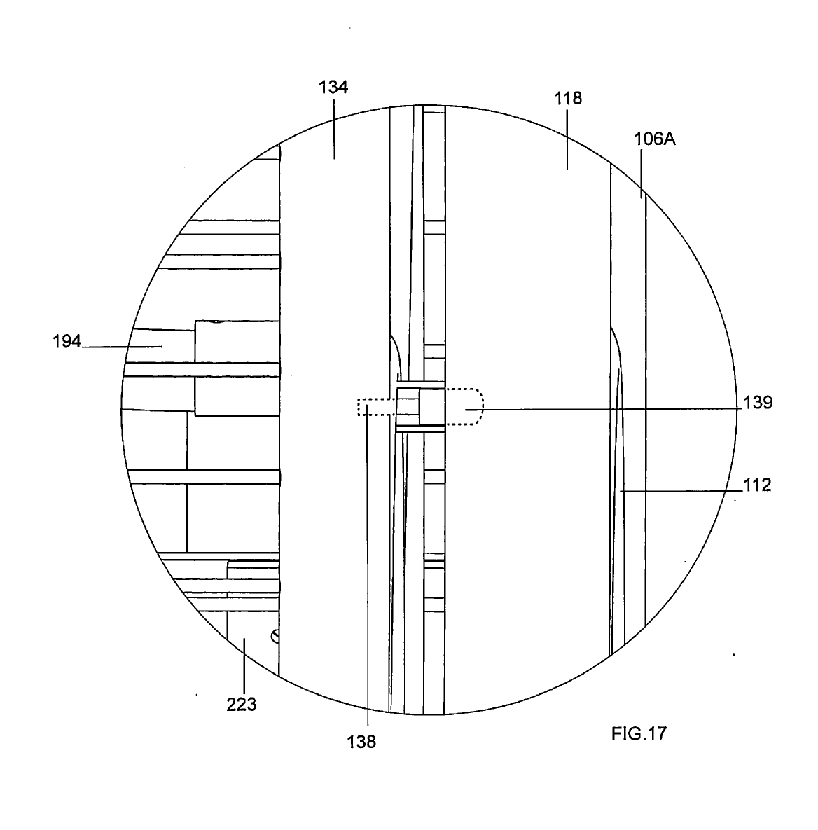

In the embodiment illustrated in FIG. 17, an outer locking mechanism 210 is typically provided to prevent rotation of the support assembly 102 and hold the rotating support assembly 102 and object 2 in the closed, storage position. The outer locking mechanism 210 includes lock tabs 212A and 212B configured to engage each other and accept a combination lock from a user. Lock tab 212A further engages the base cross bar 118 so as to prevent the support assembly 102 from rotating beyond vertical in the storage position. In a further embodiment, an inner locking assembly 136 includes a locking pin 138 that can be electrically operated by a solenoid 139. The solenoid 139 is mounted to the cross bar 118, while the locking pin 138 is selectively inserted into a suitable aperture in cross bar 134 to secure support assembly 102 relative to the base assembly 104.

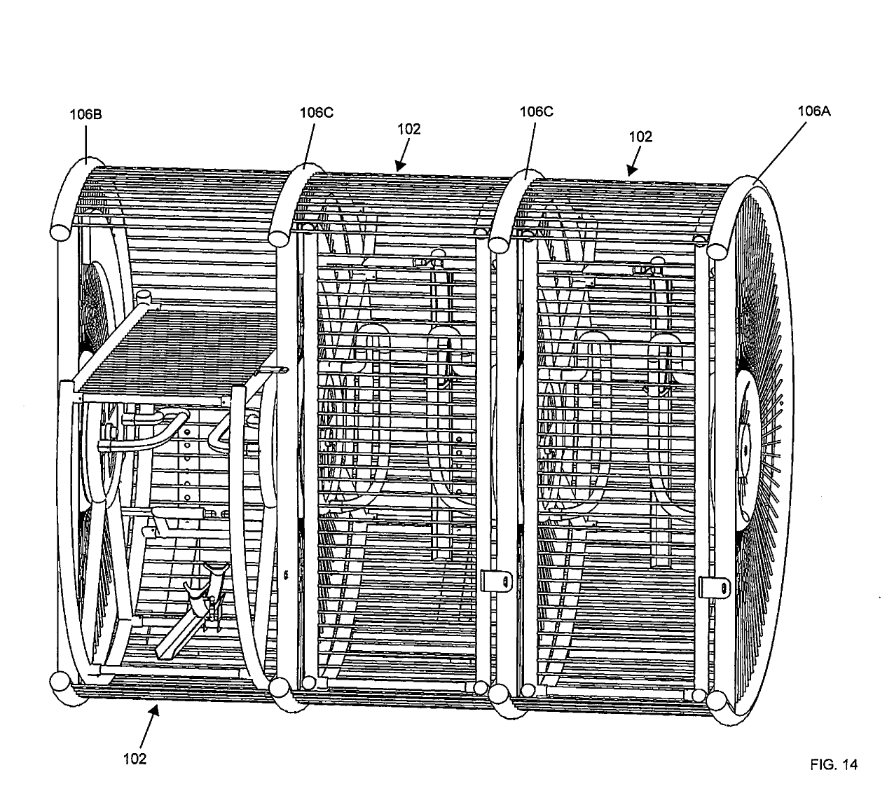

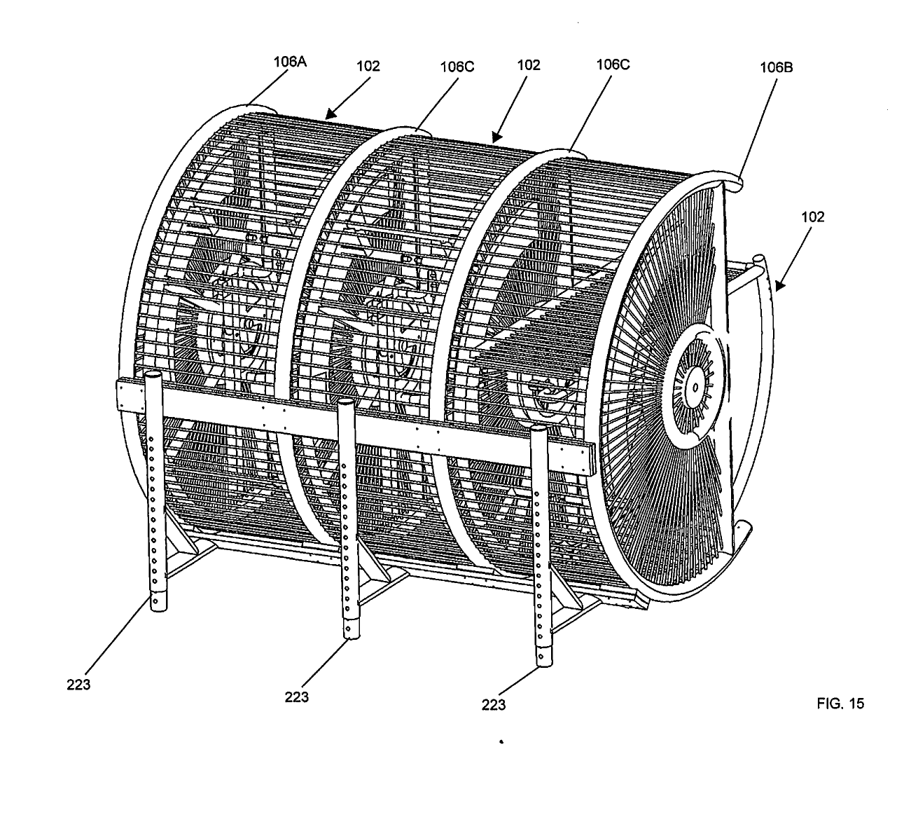

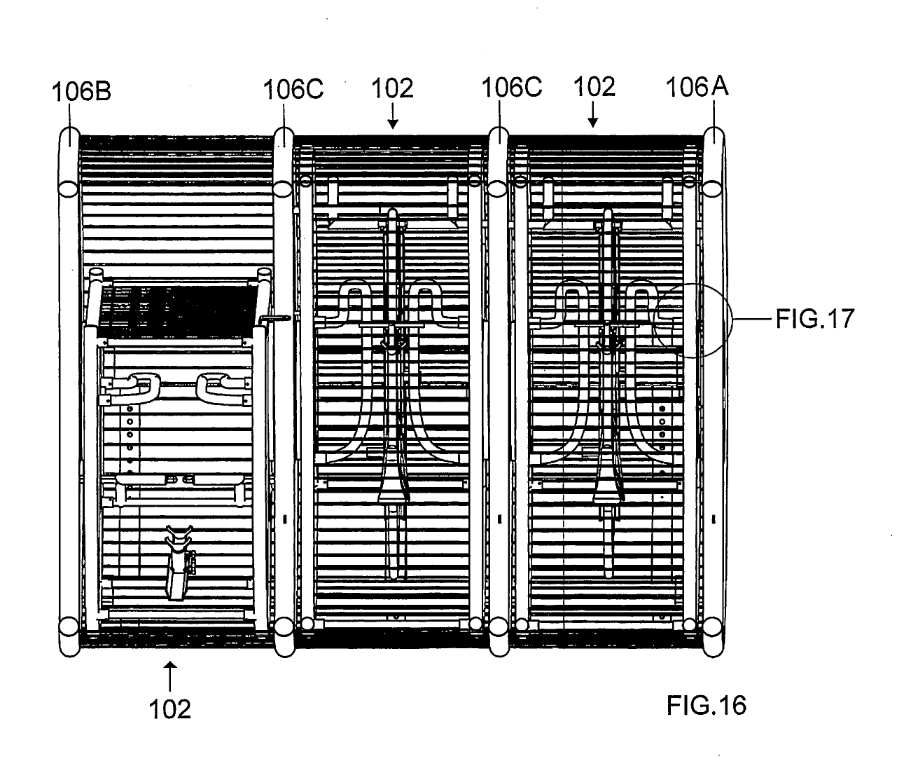

FIGS. 14-16 illustrate a plurality of storage devices 100 disposed adjacent each other in a side-by-side manner. When a plurality of storage devices 100 are so arranged, if desired, some of the structures providing support or inhibiting access may not be necessary or can be reduced in number. For example, a common frame member 106C (if desired with spokes 114 or other inhibiting structure) can be provided between adjacent storage devices 100.

FIGS. 14-16 further illustrate that storage device(s) 100 can be mounted on a vertical surface that is approximately perpendicular to a horizontal surface. For example, such a configuration can include one where the base assembly 104 is mounted on a wall such as that of a parking garage. Another exemplary configuration can include mounting the storage device 100 to the sides of a bus stop enclosure. In such a configuration where the storage device 100 is mounted to a vertical wall, the rack 104 will include a mount that can include a crossbar or a back plate.

In another advantageous embodiment, storage device 100 can include a rotating support assembly 102 that can be mounted horizontally. Under the horizontally-mounted configuration, the rotating support assembly 102 would no longer use mount discussed above in connection with the vertically-mounted configuration. Instead, the horizontally-mounted configuration of storage device 100 can use a strut 223 that extends vertically down to a horizontal surface, such as a floor or the ground to function as a base similar to that provided in the previous embodiment.

The figures used in the present application are schematic drawings, where location of the outer locking mechanism, the length of the loading tray, the overall shape of the support assembly 102 and the base assembly 104 can be varied as is necessary to accommodate the desired objects to be stored therein.

It should be noted that the elements and/or assemblies of the storage device can be connected with suitable fasteners as necessary to allow the storage device to be shipped in a disassembled state. Although the subject matter has been described in a language specific to structural features and/or methodological acts, it is to be understood that the subject matter defined in the appended claims is not necessarily limited to the specific features or acts described above as has been determined by the courts. Rather, the specific features and acts described above are disclosed as example forms of implementing the claims.

What is claimed is:

1. A storage device for an object, the storage device comprising:
a base assembly; and
a support assembly configured to rotate relative to the base assembly from a loading position to a storage position, wherein the storage position inhibits removal of the object from the support assembly.

2. The storage device of claim 1, wherein the support assembly comprises an access opening through which the object is loaded on the support assembly, wherein in the loading position removal of the object through the access opening in the storage position is inhibited.

3. The storage device of claim 2, further comprising a loading mechanism configured to receive the object through the access opening.

4. The storage device of claim 3, wherein the loading mechanism comprises a loading tray configured to receive wheels of a bicycle and guide the wheels thereon.

5. The storage device of claim 4, further comprising a steering guide configured to direct handlebars of the bicycle and hold the bicycle in an upright position.

6. The storage device of claim 1, further comprising a counterweight disposed on the support assembly and configured to aid in moving the support assembly from the open, loading position to the closed, storage position.

7. The storage device of claim 3, wherein the loading mechanism comprises a moveable wheel support configured to engage the wheel of a bicycle and prevent backwards movement of the bicycle as the support assembly begins movement toward the closed, storage position.

8. The storage device of claim 1, further comprising an object holding assembly configured to hold the object from falling in the storage position.

9. The storage device of claim 1, further comprising a motion control mechanism operably configured to dampen rotation of the support assembly relative to the base assembly.

10. The storage device of claim 1, further comprising a motion control mechanism configured to aid in rotating the support assembly from the loading to the storage position.

11. The storage device of claim 1, further comprising a motion control mechanism configured to aid in rotating the support assembly from the loading to the storage position and operably configured to dampen rotation of the support assembly relative to the base assembly.

12. The storage device of claim 11, wherein the motion control mechanism is a lift support.

13. The storage device of claim 11, wherein the motion control mechanism is an actuator.

14. A storage device for an object, the storage device comprising:
a base assembly comprising interconnected base frame members; and
a support assembly configured to rotate relative to the base assembly from a loading position to a storage position, the support assembly comprising interconnected support frame members to define an access opening through which the object is inserted into the storage device in the loading position, wherein at least one of the base assembly and support assembly includes elements to inhibit removal of the object from the storage device in the storage position.

15. The storage device of claim 14, wherein the elements to inhibit removal of the object from the storage device in the storage position are disposed on each of the base assembly and the support assembly.

16. The storage device of claim 15, wherein the elements to inhibit removal of the object from the storage device on the support assembly rotate with the support assembly during movement from the loading position to the storage position.

17. The storage device of claim 16, wherein the interconnected base frame members define a base assembly opening through which the object is inserted through in the loading position.

18. The storage device of claim 17, wherein the elements to inhibit removal of the object from the storage device on the support assembly inhibit removal of the object through the base assembly opening in the storage position.

19. The storage device of claim 14, wherein the access opening through which the object is inserted into the storage device faces downwardly toward a support surface of the base assembly in the storage position.

20. A storage device for an object, the storage device comprising:
a base assembly; and
a support assembly configured to rotate relative to the base assembly from a loading position to a storage position, the support assembly comprising interconnected support frame members to define an access opening through which the object is inserted into the storage device in the loading position, the support assembly including a holding device configured to hold the object in at least an inclined position so as to inhibit removal of the object through the access opening in the storage position.

21. The storage device of claim 20, further comprising a counterweight disposed on the support assembly and configured to aid in moving the support assembly from the open, loading position to the closed, storage position.

22. The storage device of claim 20, further comprising a motion control mechanism configured to aid in rotating the support assembly from the loading to the storage position and operably configured to dampen rotation of the support assembly relative to the base assembly.
